(19) United States
(12) Patent Application Publication
(10) Pub. No.: US 2014/0266967 A1
(43) Pub. Date: Sep. 18, 2014

(54) Metamaterial Particles for Electromagnetic Energy Harvesting

(71) Applicants: Omar Ramahi, Waterloo (CA); Thamer Almoneef, Waterloo (CA); Mohammed AlShareef, Waterloo (CA)

(72) Inventors: Omar Ramahi, Waterloo (CA); Thamer Almoneef, Waterloo (CA); Mohammed AlShareef, Waterloo (CA)

(21) Appl. No.: 13/841,652

(22) Filed: Mar. 15, 2013

(51) Int. Cl. H01Q 21/06; H01Q 7/00

(52) U.S. Cl. CPC H01Q 21/061; H01Q 7/00
USPC 343/867

(57) ABSTRACT

Antennas developed for electromagnetic field energy harvesting, typically referred to as rectennas, provide an alternative electromagnetic field energy harvesting means to photovoltaic cells if designed for operation in the visible frequency spectrum. Rectennas also provide energy harvesting ability or power transfer mechanism at microwave, millimeter and terahertz frequencies. However, the power harvesting efficiency of available rectennas is low because rectennas employ traditional antennas whose dimensions is typically proportional or close to the wavelength of operation. This invention provides a device for electromagnetic field energy harvesting that employs a plurality of electrically-small resonators such as split-ring resonators that provide significantly enhanced energy harvesting or energy collection efficiency while occupying smaller footprint. The invention is applicable to electromagnetic energy harvesting and to wireless power transfer.

### CROSS-REFERENCE TO RELATED APPLICATIONS

This invention claims priority to pending U.S. Provisional Patent Application No. 61652921, entitled Metamaterial Particles for Electromagnetic Energy Harvesting, filed on Jun. 12, 2012, the contents of which are herein incorporated by reference.

### STATEMENT REGARDING FEDERALLY SPONSORED RESEARCH OR DEVELOPMENT

Not Applicable

### FIELD OF THE INVENTION

This invention relates generally to electromagnetic energy harvesting systems, and particularly to wireless power transfer systems and rectenna systems operating at microwave, millimeter, terahertz, infrared and visible spectra frequency regimes. In addition, the invention further relates to applications where electric energy is needed such as Space Solar Power (SSP) systems, Radio Frequency Identification (RFID) systems, charging batteries, etc.

### BACKGROUND OF THE INVENTION

Fears of depletion of conventional energy resources based on fossil fuels coupled with the serious environmental impact that such resources impose are the main drivers for the increasing interest in renewable and sustainable energy. Common types of existing renewable energy harvesting systems include, but are not limited to, tidal, geothermal, wind and solar energy. Due to the enormous amount of electromagnetic energy emitted by the sun, researchers have focused on developing systems that can harness solar energy. The energy emitted by the sun spans a bandwidth of wavelengths ranging between approximately 0.1 μm-4 μm. It is estimated that of the total energy radiated by the sun, 7% is in the form of ultraviolet (0.1 μm-0.4 μm), 44% lies in the visible light band (0.4 μm-0.71 μm) and the rest is concentrated at the near- and far-infrared region (0.71 μm-4 μm). The percentages of the solar energy distribution vary slightly close to the ground level [Pidwirny, M. (2006). “The Nature of Radiation”. Fundamentals of Physical Geography, 2nd Edition]. Solar cells are a common type of technology that makes use of solar energy, which is based on the photovoltaic effect that converts photon energy to DC power by using semiconductor materials. Photovoltaics in most cases are capable of harvesting a limited band of the solar spectrum, 0.4 μm-0.71 μm. The performance of photovoltaic cells is limited to the type of semiconductor material used. Generally, the energy conversion efficiency energy of solar panels is between 11% and 27% [National Energy Education Development Project, Solar, secondary energy infobook. National Energy Education Development Project. Manassas. P42. (2012).]. This percentage is greatly dependent on its installment location and is affected by poor weather conditions, such as dust. Moreover, photovoltaics depend on direct sunlight illuminations and therefore it cannot function at night. In addition to the energy radiated by the sun, there is an abundance of thermal infrared radiation on the surface of the earth due to the cooling process of the earth at night time. If used effectively, this source of power along with the great amount of solar energy untapped by photovoltaics, could provide clean and sufficient amount of energy that could meet the globe's growing energy demand in a very highly efficient manner.

Another method for harvesting the energy emitted by the sun is by using nano-antennas that can capture the electromagnetic solar energy then rectify the energy using fast switching tunneling diodes. This method is commonly referred to in the literature, as a rectenna (rectifying antenna) system. The rectenna concept was proposed in the 1970's by Brown [W. C. Brown, “The receiving antenna and microwave power rectification,” Journal of Microwave Power, 5,279 (1970)] and Bailey [R. L. Bailey, “A proposed new concept for a solar energy converter,” Journal of Engineering for Power, 73 (1972).] and has since then become an intriguing topic for researchers. If properly designed, one of the advantages of this method is that, not only can it harvest the solar energy but also it can be applied to recycle the available electromagnetic energy that is continuously around us due to communication applications or many others operating at the microwave spectrum. A general structure of a basic rectenna system consists of five main elements. The electromagnetic energy is captured using a receiving antenna operating at the desired frequency. Then, a filter is used to suppress the unwanted harmonics caused be the nonlinear behavior of the diode and match the antenna impedance to that of the diode. After the AC power transfers from the antenna through the filter, a Schottky or MIM diode is used to rectify or convert the collected AC power to DC. An additional low-pass filter can be connected after the diode for eliminating any remaining AC components before reaching the power load. The power level harnessed by rectenna systems can range depends on several factors but had been typically observed to be in the milli-Watt range. For such system to become more effective, the collector used should be highly efficient. In most of the existing rectenna systems, antennas are used as the primary element or mechanism for collecting the time-varying (sinusoidal) electromagnetic energy. However the efficiency of the antennas has not been highlighted in existing related literature, and therefore a study of the efficiency of antennas is required to fairly evaluate the efficacy of recenna systems vis-à-vis other technologies. Furthermore, since the antenna is the largest component in a rectenna system, it limits the type of application where the rectenna can be utilized, especially for those applications where the size of the rectenna is critical.

Consequently, because of the low efficiency of current rectenna systems, an improvement in the primary elements responsible for electromagnetic energy collection or electromagnetic energy harvesting is needed. What is needed in the art is a collector element that is more efficient than existing collectors (such as classical antennas) and smaller in size so it can be utilized in applications where the size of the system is critical.

### SUMMARY OF THE INVENTION

The current invention describes a new method for harvesting electromagnetic energy based on metamaterial particles. Metamaterial particles are the primary constitutive elements used to create metamaterial, which can be described as an artificial media with unusual electromagnetic properties such as negative index of refraction or negative permittivity or negative permeability [L. Solymar and E. Shamonina, Waves in metamaterials. Oxford University Press, USA, 2009]. Metamaterials are formed by assembling electrically small resonators (ESR) that can take various shapes, geometries and compositions. One of the most common types of ESRs used for metamaterials is the class of split-ring resonators (SRR) which is broadly described as a single or multiple metallic (conductive) loops with one or more splits or gaps suspended in a host non-conductive medium or deposited/printed on a non-conductive substrate. An SRR can be made of single or multiple and concentric or parallel electrically small rings that need not be perfectly circular. It can also take various shapes such as those studied in [M. Bait Suwailam. Metamaterials for Decoupling Antennas and Electromagnetic Systems. PhD thesis, University of Waterloo, P.32, (2011)] or in [L. Solymar and E. Shamonina, Waves in metamaterials. Oxford University Press, USA, 2009]. Metamaterials can be made by other class of electrically small particles such as simple closed loops of varying topologies without any splits or gaps. What is unique to all types of electrically-small resonators is that their size is much smaller than the wavelength at which they operate. The frequency corresponding to their operation is referred to as the resonance frequency. The resonance phenomenon of the ESR is highly similar to an LC circuit where a capacitor is connected to an inductor. By the resonance of such LC circuit, it is implied that a current can be sustained within the circuit without any active external excitation or source. Of course, energy has to be transferred to the LC circuit somehow (inductively or by other means) in the first place. The ESR resonance mechanism is highly similar to the LC circuit resonator in the sense that a current is generated within the ESR that is due to an external electromagnetic field incident on the ESR. Thus it is critical to realize that the resonance phenomenon of the ESRs such as the split-ring resonators or other metallic electrically small resonators is fundamentally different from the resonance of half-wave length dipole antennas, wide-band log-periodic antennas, microstrip patch antennas, or other type of resonant antennas that have dimensions comparable or close to the wavelength corresponding to the operation frequency. Resonance of such classical antennas implies the frequency at which the input impedance becomes purely resistive. In ESRs, resonance refers to the phenomenon of creating a current in the resonator implying the ability of the ESR to absorb electromagnetic field energy. In the case of the SRR, at the resonance frequency, the SRR experiences a relatively high electric field within its gap which suggests a buildup of relatively high voltage across its gap (higher than the case when the frequency is not the resonance frequency of the SRR), indicating the ability of the SRR to harvest or collect electromagnetic energy. Further, the harvesting method of this invention utilizes the energy stored in the gap of the resonator by means of a resistive load placed across the gap/split. The resistive load mimics the equivalent impedance of the rectifier circuit, commonly used in rectenna systems. Alternatively, a diode or rectifier can be placed across the gap of the SRR which is then connected to a specific load to deliver the harvested/collected electromagnetic field power.

This method has the advantage of capturing electromagnetic energy more efficiently than the collectors available in the current art, (i.e., classical antennas or radiators). In addition, the electrically small resonators are much smaller in size than conventional antennas, thus enabling incorporation the electromagnetic energy harvesting structure into many systems where size is of critical importance. Primarily, when a multiple of electrically small resonator particles are stacked, the coupling between two adjacent cells can widen the bandwidth of the total system, increasing the range of frequencies over which the energy is collected. The description of the invention section, shall explain in details the full embodiment including the working mechanism of the harvesting collector along with a numerical simulation. In addition, an experiment performed in the laboratory is presented in details to allow and familiarize an unskilled layperson to practice the present invention.

### BRIEF DESCRIPTION OF THE DRAWINGS

FIG. 1 is a view of a single loop Split Ring Resonator, an example for metamaterial unit cell.

FIG. 2 is a view of an equivalent circuit model of a single loop SRR loaded with a resistor across its gap.

FIG. 3 is useful to illustrate the reciprocity theorem for a single loop SRR and a dipole antenna.

FIG. 4 is an illustration useful to understand the efficiency of collectors to harvest electromagnetic energy.

FIG. 5 is view of the experimental setup equipment used in the laboratory.

FIG. 6 is a view of two identical footprints occupying a 9×9 SRR array and a 3×3 patch antenna array, useful for power efficiency comparison.

FIG. 7 is a chart showing the power efficiency of a patch antenna resonating at 5.8 GHz as a function of varies coax probe positions.

FIG. 8 is a view of various antenna array configurations placed in identical footprints, useful for optimizing the number of anennas with respect to maximum power efficiency.

FIG. 9 is a chart showing the energy harvesting efficiency of 4, 5, 6, 8, and 9 antenna array placed in the same footprint as a function of operating frequency.

FIG. 10 is a view of a simulation setup for energy harvesting using a horn antenna as the source of radiation and an SRR array as the collector.

FIG. 11 is a chart showing energy harvesting efficiency of the 9×9 SRR array and 3×3 patch antenna array as a function of frequency: both arrays placed in the same footprint and tilted at an angle of 30° with respect to an axis shown in FIG. 10.

FIG. 12 is a chart showing energy harvesting efficiency of the 9×9 SRR array and 3×3 patch antenna array as a function of frequency: both arrays placed in the same footprint and tilted at an angle of 45° with respect to an axis shown in FIG. 10.

FIG. 13 is a chart showing energy harvesting efficiency of the 9×9 SRR array and 3×3 patch antenna array as a function of frequency: both arrays placed in the same footprint and tilted at an angle of 60° with respect to an axis shown in FIG. 10.

FIG. 14 is a view of a single loop Split Ring Resonator, an example for metamaterial unit cell, showing the placement of a rectifying diode positioned across the gap.

### DETAILED DESCRIPTION OF THE INVENTION

The invention describes a novel electromagnetic energy collector based on metamaterial particles. The new collector is an electrically small resonator (ESR) commonly referred to as a Split Ring Resonator (SRR). Electrically small resonators can be made of single or multiple metallic loops with at least one split. Without loss of generality, a single loop SRR is presented as described below. However, the described harvesting method can be applied to other electrically small resonators that have been studied in the literature. Additionally, the invention applies to electrically small resonators that are made of electrically-conductive material suspended in non-conductive host medium or printed/etched on non-conductive substrates (dielectric material).

A single-loop SRR (FIG. 1) can be realized as a simple RLC circuit where the size of the gap (gxw) 12 and the arm length of the metallic ring 14 contribute mainly to the total capacitance and inductance of the structure, respectively. Hence, by varying these dimensions, one can design an SRR to resonate at a specified frequency. The resonance phenomena of an SRR can be achieved by an impinging magnetic field normal to the SRR structure. Even if the incident field is incident at an angle to the normal, resonance can be excited in the SRR leading to a concentration of electric field across the gap. Since the gap is sufficiently small electrically, we can interpret the field buildup across the gap as a voltage. In other words, the field illuminated SRR becomes a voltage source. The fact that an SRR develops a relatively high electric field within its gap at resonance frequency, which implies a buildup of high voltage across its gap, is indicative of its ability to harvest electromagnetic energy. This invention provides a method for a single loop SRR 14 deposited on a substrate 13 to harvest electromagnetic energy by means of resistive load placed across the gap of the resonator. In lieu of the resistive load, a rectification circuit, or diode, can be placed across the gap to convert the AC field arriving incident at the SRR into DC energy. However, such method can be used to harvest electromagnetic energy developed within other electrically small resonators with different geometries. The resistive load is, considered in this work, the Thevenin equivalent of a rectifying circuit connected to a power load. The equivalent circuit model of a single loop SRR loaded with a resistor is shown in FIG. 2, where R is the total resistance 26, L is the total inductance 24, and C represents the total capacitance 25 of the SRR. The resistance of the connected load is represented by R_{L} 22. Here, it is assumed that the resonator is operating at resonance frequency, being illuminated by an impinging electromagnetic field. Essentially, the SRR is considered a dependent source of energy (dependent on the incident field) whose output voltage, i.e., the voltage induced at the gap 23, depends not only on the frequency of the incident field but also on the topology and size of the SRR, but more critically on the impedance of the gap.

A single loop SRR cell was designed using the full-wave simulator HFSS to resonate at 5.8 GHz. The designed SRR has dimensions of L=5.9 mm, w=0.55 mm and g=0.8 mm (FIG. 1). Since the optimal resistance value is not known, the resistive sheet that is placed across the gap to mimic a load is assigned a variable resistance value ranging between 10 and 10,000 Ohms. The SRR is then excited by a plane wave such that the magnetic field is predominantly perpendicular to the SRR plane. The efficiency of the SRR is then calculated by using the proposed efficiency concept discussed below. It was found that a single SRR cell has an efficiency of around 40%, with an optimal resistive load of 2.3 K [O. Ramahi, T. Almoneef, M. Alshareef, and M. Boybay, “Metamaterial particles for electromagnetic energy harvesting,” Applied Physics Letters, vol. 101, no. 17, pp. 173 903-173 903, 2012]. This result suggests that the energy developed across the gap is mostly dissipated by the resistive sheet. Therefore, such SRR structures can be used for harvesting electromagnetic energy.

In order for any radiator to receive energy, it must obey the reciprocity theorem. With reference to FIG. 3, this theorem states that in any network composed of linear, bilateral, lumped elements, if one places a constant current generator 32 between two nodes (in any branch) and places a voltage meter 33 between any other two nodes (in any branch), makes observation of the meter reading, then interchanges the locations of the source 32 and the meter 33, the meter reading will be unchanged [C. A. Balanis. Antenna theory: analysis and design. J. Wiley, 2005.]. To ensure that the theorem is not violated, an experiment in HFSS is conducted by designing two radiators, a dipole antenna 34 and a single loop SRR 31 both resonating at the same frequency. The experiment is divided into two cases (FIG. 3):

1.) An SRR is excited by a current source placed across its gap: then the voltage across the feed of the dipole antenna is recorded.
2.) A dipole antenna is excited by a current source placed at its feed; then the voltage across the gap of the SRR is recorded.

The voltage of both cases can be found by V=E×d, where E denotes the electric field, and d is the length of the feed (for the dipole) and the length of the gap (for the SRR). It was found through simulation that the average electric fields developed across and the dipole antenna and the gap of the SRR are 3.8562×10⁴ V/m and 5.988×10⁴ V/m respectively [T. Almoneef, “Antennas and Metamaterials for Electromagnetic Energy Harvesting,” MASc. dissertation, University of Waterloo, 2012]. Therefore, knowing that the feed length for the dipole antenna is 1.23 mm and the gap length for the SRR is 0.8 mm, the voltages for both cases are:

V₁=E₁·d₁=(3.8562×10⁴)×(1.23×10⁻³)=47.43 V for case 1

V₂=E₂·d₂=(5.988×10⁴)×(0.8×10⁻³)=47.907 V for case 2

It is evident from the voltage values of both cases that the SRR obeys the reciprocity theorem and therefore can be used for collecting electromagnetic energy.

Next, we examine the efficiency performance of a single electromagnetic energy collector or a plurality of collectors assembled periodically or non-periodically in an array format. Here, what is meant by electromagnetic energy collection efficiency is the ability of the collector to convert the power incident on a specific area or footprint to available power at the load. Therefore, a footprint in square meters must be defined over which a number of collectors are placed in such a way that the power collected is maximized. An example that can illustrate this efficiency concept is in utilizing a rooftop of a building 44 for energy harvesting as shown in FIG. 4. The defined area (AXB) 42 in square meters of the rooftop is to be filled with an array of collectors 43 that maximally converts the incident power 41 to available power at all feeds of the collectors.

Hence the efficiency of a collector or an ensemble of collectors as defined above can be found as follows:

$$η = \frac{{P}_{ave}}{{P}_{area}}$$

where Pₐᵣₑₐ is the total time-average power incident on the footprint, and Pₐᵥₑ is the maximum available time-average ac power received by the collector or all collectors occupying the specific footprint under consideration and is available at the feed terminal of the receiving collector. Therefore, Pₐᵥₑ is given by the following relation:

$${P}_{ave} = {\sum }_{i = 0}^{n} \frac{{V}_{i}^{2}}{{R}_{i}}$$

where Vᵢ and Rᵢ are the voltage across and the resistance of collector i. The total number of collectors on a specific footprint is denoted by n.

### Experimental Results:

The feasibility of using an SRR to harvest electromagnetic energy is validated by testing and measurements. First, the single loop SRR simulated above was fabricated using a Rogers Duroid RT5880 substrate with a thickness of 0.79 mm. Then the SRR was loaded with a surface mount resistor of 2.7 KΩ. Here, the resistor used in the experiment is different from that of the optimal resistor (2.3 K) obtained from the simulation since the latter was not available at the time of the experiment. An experiment was then conducted using the following measurement setup (FIG. 5): a commercially available 17 dBi gain array antenna operating at 5.8 GHz, an Agilent Infiniium 91304ADSA 12 GHz oscilloscope equipped with a single-ended probe 54, a high frequency 30 dBm power source and the fabricated single loop SRR designed to resonate at 5.8 GHz. The SRR was placed a distance r 52 of 30 cm away from the antenna, and was positioned in such a way that the H-field of the illuminated wave was perpendicular to the plane of the structure. The antenna was excited by a power source with a power level of 24 dBm. Then the voltage across the resistor of the SRR was measured using a single-ended probe of the oscilloscope. The voltage readings obtained from the Infiniium oscilloscope showed that the voltage measured across the resistor 55 was approximately 611 mV.

The result obtained from the above experiment indicates that an SRR can be used to collect electromagnetic energy. However, the performance of the proposed collectors (SRRs) must be compared with existing collectors (antennas) to understand the viability of incorporating them in existing electromagnetic energy systems such as rectenna systems. Therefore, the next section studies the performance of an SRR array as compared to an antenna array in terms of total power efficiency.

SRR Array Vs. Patch Antenna Array

A demonstration is presented comparing the efficiency of an array of SRRs with an array of patch antennas both placed on the same footprint (area) as shown in FIG. 6. The array of SRRs contained 81 single loops; all loops of identical size and designed to resonate at around 5.85 GHz. In addition, an array of 3×3 identical patch antennas was placed in the same footprint, each resonating at the same frequency of around 5.85 GHz. The total footprint area is 85×85 mm². To maximize the power collected by the antennas that occupy the defined footprint, two essential experiments were conducted. First, the feed position of the coax-probe patch antenna was varied and the position that yielded the maximum power collected was selected. Additionally, various antenna configurations depending on the distance between two adjacent antennas and the total number of collectors were investigated and the best case was selected for comparison.

Each antenna was fed by a coax probe from beneath. The performance of a probe-fed patch antenna is greatly dependent on the feed position 61 with reference to FIG. 6. Hence, the feed position was first analyzed by varying the location of the coax with a distance r away from the center of the patch and along the axis parallel to the largest dimension of the patch antenna, as shown in FIG. 6. It was found that the best performance of the antenna was achieved when the probe was placed a distance of 2 mm away from the center of the antenna, as shown in FIG. 7. Hence, this coax probe position is selected for all the antennas occupying the defined footprint. It was reported in the literature that antennas need to be separated by approximately λ/2 to retain their characteristics such as radiation pattern and gain [B. Lau and Z. Ying, “Antenna design challenges and solutions for compact mimo terminals,” 2011]. Therefore, five different configurations were studied to ensure that the optimal antenna configuration was selected. In each case the antennas were placed in such a way that the distance between two adjacent antennas was maximum to reduce the coupling effect and to ensure maximum power collection by the antennas. The five cases are shown in FIG. 8, where the number of antennas was varied between 4 and 9 antennas. It was found through numerical simulation that the antenna configuration containing 9 antennas resulted in the maximum power efficiency as indicated by FIG. 9, and therefore is selected to be compared with an SRR array.

The performance of the 3×3 antenna array was then compared with a 9×9 SRR array in terms of total power efficiency. Referring to FIG. 10, each array was excited by a horn antenna 106 placed a distance d 105 of 120 cm away from the array to ensure that the far field condition was satisfied and a plane wave was incident on the array (this type of excitation is the basis used for all the array simulations discussed in this section). Since both the antenna and the SRR are polarized differently, each array was tilted an angle φ 104 with respect to the x-axis as indicated in FIG. 10. Three tests were conducted for each array, with incident field angles of 30°, 45°, and 60°. FIGS. 11, 12, and 13 show the efficiency of the antenna array and the efficiency of the SRR array at each of the angles, respectively. Table I summarizes the results obtained. In the table, the bandwidth was calculated by considering the range of frequencies where the efficiency exceeds 70% of the peak power efficiency.

TABLE I

| Collector | Incident | Maximum Efficiency | Bandwidth |
|---|---|---|---|
| Type | angle | (%) | (GHz) |
| SRR | 30° | 53.37 | 1.57 |
| Array | 45° | 51.84 | 2.06 |
| | 60° | 76.31 | 2.14 |
| Antenna | 30° | 30.56 | 0.18 |
| Array | 45° | 25.52 | 0.12 |
| | 60° | 23.21 | 0.10 |

From the results obtained, the following observations can be drawn: The SRR array resulted in higher efficiency for all the three incident field angles. In addition, the SRR structure is much smaller in size than the antenna in the specific footprint mentioned above, which can contain either 81 SRRs or only 9 patch antennas. Most importantly, the bandwidth over which the energy is collected for the SRR array is much wider than that of the antenna array. For instance, the SRR array resulted in at least 1.5 GHz bandwidth over which the efficiency exceeds 40% while the antenna array resulted in a bandwidth of 250 MHz of efficiency that exceeds only 10%. For SRRs, the coupling between adjacent elements has a constructive effect on the total collected power since the total efficiency of a single SRR is only 40% while the efficiency of an array of SRRs can yield to an increase of up to 35% as compared to the single SRR case. However, for antennas, the coupling between adjacent elements can yield to a reduction in the total power collected and therefore the distance between two adjacent antennas must be optimized to maximize the total power collected by the array.

Having thus described the invention, what is claimed is:

1. An electromagnetic energy collecting or harvesting device comprising:
at least one electrically small resonator to receive electromagnetic field power at a plurality of angles of incidence and converts the electromagnetic field power to AC or DC signal;
at least an ensemble of electrically small resonators arranged periodically or non-periodically on a flat plane or stacked vertically to receive electromagnetic field power at a plurality of angles of incidence and to converts the electromagnetic field power to AC or DC signal.

2. The device of claim 1 wherein the electromagnetic energy collecting or harvesting device operates in the microwave, millimeter, terahertz, infrared or visible frequency regimes.

3. The device of claim 1 wherein electrically small resonators can be metamaterial particles made of conductive material suspended in non-conductive media or etched or printed on non-conductive (dielectric) substrates.

4. The device of claim 1 wherein electrically small resonators include metamaterial particles typically used to create metamaterials of negative permittivity, negative permeability or negative permeability and negative permeability.

5. The device of claim 1 wherein electrically small resonators include split-ring resonators composed of single or multiple loops having one or more splits or gaps.

6. The device of claim 1 wherein electrically small resonators include split-ring resonators positioned next to strip lines or metallic surfaces to increase energy collection efficiency.

7. The device of claim 1 wherein the electrically small resonator is designed to operate at a specific range of frequencies.

8. The device of claim 1 wherein an ensemble of electrically small resonators are designed to operate at different frequencies.

9. The device of claim 1 wherein the electrically small resonator is scaled to operate in the infrared or visible frequency spectrum.

10. The device of claim 1 wherein the distance between the electrically small resonators can be adjusted to exploit element coupling that leads to enhancement in the frequency bandwidth.

11. The device of claim 1 wherein the energy collector element or elements are connected to a rectifier or diode to convert the AC power to DC power.

12. The device of claim 1 wherein the ensemble of energy collectors are used to receive wirelessly transmitted power from an intentional or non-intentional electromagnetic power transmitter.

13. The device of claim 1 wherein electrically small resonators used for energy harvesting can be further miniaturized using capacitors or inductors placed within the electrically small resonator.

14. The device of claim 1 wherein a single or plurality of collectors stacked in a planar fashion or vertically is used to collect power from intentional or unintentional radiators to charge nearby or remotely located batteries.
